(19) United States
(12) Patent Application Publication
(10) Pub. No.: US 2023/0173447 A1
(43) Pub. Date: Jun. 8, 2023

(54) METHOD OF DETERMINING SUPERFICIAL GAS VELOCITY IN FLUIDIZED BED REACTORS

(71) Applicant: ExxonMobil Chemical Patents Inc., Baytown, TX (US)

(72) Inventors: Shayan KARIMIPOUR, Katy, TX (US); Ryan W. IMPELMAN, Houston, TX (US); Sebastian CHIALVO, Spring, TX (US); Gerardo CORONA, Friendswood, TX (US)

(21) Appl. No.: 18/161,536

(22) Filed: Jan. 30, 2023

Related U.S. Application Data
(60) Provisional application No. 63/267,693, filed on Feb. 8, 2022.

(51) Int. Cl. B01J 8/18; B01J 8/24

(52) U.S. Cl. CPC B01J 8/1809; B01J 8/1827; B01J 8/24; B01J 8/1872; B01J 2208/00539; B01J 2208/00584; B01J 2208/00548; B01J 2208/00725; B01J 2208/00672; B01J 2208/00575

(57) ABSTRACT

Systems and methods useful in determining the superficial gas velocity in fluidized bed reactors may utilize a pressure drop across a portion of the system but not associated with a flowmeter. For example, method may comprise: obtaining a pressure for each of two different locations within a fluidized bed reactor system that comprises a reactor capable of containing a fluidized bed and a cycle gas loop, wherein one or both of the two different locations is not at a flowmeter; calculating a pressure drop based on the two pressures; calculating a first superficial gas velocity (SGVₐₗₜ) for the fluidized bed based on the pressure drop; and operating the fluidized bed reactor system based at least in part on the SGVₐₗₜ.

### CROSS-REFERENCE TO RELATED APPLICATION

This application claims the benefit of U.S. Provisional Application 63/267,693 filed Feb. 8, 2022, entitled “Method of Determining Superficial Gas Velocity in Fluidized Bed Reactors”, the entirety of which is incorporated by reference, herein.

### FIELD OF INVENTION

The present application relates to systems and methods for determining the superficial gas velocity in fluidized bed reactors, for example, polyolefin reactors.

### BACKGROUND

The superficial gas velocity in fluidized bed reactors is monitored and regulated to maintain fluidization of the bed and proper functionality of the reactor. The proper superficial gas velocity provides a well-mixed bed and removes the heat produced by reactions (e.g., polymerization) occurring in the reactor. Superficial gas velocity is the speed of the gas in the straight section of the reactor.

Current efforts to monitor the superficial gas velocity within a fluidized bed reactor use a Venturi flowmeter or related instrument (e.g., a Pitot tube) to provide a gas flowrate through the cycle gas pipe. The Venturi flow meter readings need to be compensated for changes in gas density for Venturi flow measurement to be accurate. From said gas flow rate, the superficial gas velocity can be derived. However, such gas flow rate measurements may be hindered by the accumulation of granular particles or polyolefin reactor foulants that are in the cycle gas piping and in the cycle gas purge used on the instrument pressure taps or on the throat of the Venturi flowmeter, which creates inaccuracy in the gas flow rate measurements. These inaccuracies may be sudden (e.g., from plugging of the Venturi flowmeter taps or throat), may slowly accumulate over time, or may be somewhere between. Inaccurate measurements of the gas flow rate may lead to inefficient bed fluidization, mixing, and heat removal, as well as increased particle entrainment into the cycle gas line that could lead to severe cooler or plate fouling leading to repeat reactor shutdowns and extended outage to clean cooler and/or distributor plate.

Remedial actions exist for the correction of granular particles or polyolefin reactor foulants from accumulating in the instrument taps like use of automated high-flow purge blowbacks. High-flow purge blowbacks may be performed proactively (e.g., as often as hourly) to mitigate the accumulation of granular particles or foulants that could plug either the low- or high-pressure side taps on the Venturi flowmeter. These instrument taps can also be drilled to clear any obstruction that can't be removed by purge blowbacks. However, such actions taken may not address the fouling within the Venturi flowmeter taps or cause an offset within a pressure tap, thereby reducing the effectiveness of the Venturi flowmeter and requiring a reactor shutdown to clean or replace the Venturi flowmeter.

Further, general use and these proactive measures to mitigate fouling of the taps or Venturi throat may cause the measurements of the Venturi flowmeter to drift over time. This slow drift is hard to detect until measurement inaccuracies cause the operation of the fluidized bed to clearly be outside appropriate operating parameters.

Inaccurate measurements of superficial gas velocity can lead to significant efficiency and operating cost losses in the reactor processes. For example, in polyolefin production, the gas flowing through the fluidized bed removes heat from the reactor. If the superficial velocity is too low there will not be as much heat removal forcing lower production rates, which can be costly. On the other hand, higher superficial gas velocities can lead to increased particle entrainment resulting in cooler and/or distributor plate fouling that may force a shutdown for cleaning. Further, higher superficial gas velocities require more energy. Accordingly, minor errors in superficial gas velocity can either (1) reduce polymer production (e.g., if the superficial gas velocity is actually lower than measured) or (2) cause costly downtime as a result of unplanned reactor shutdowns due to more frequent cooler and/or plate fouling and cleanings (e.g., if the superficial gas velocity is actually higher than measured). One or both of these may lead to millions to tens of millions in revenue lost annually.

### SUMMARY OF INVENTION

The present application relates to systems and methods for determining the superficial gas velocity in fluidized bed reactors, for example, polyolefin reactors.

A nonlimiting example method of the present disclosure comprises: obtaining a pressure for each of two different locations within a fluidized bed reactor system that comprises a reactor capable of containing a fluidized bed and a cycle gas loop, wherein one or both of the two different locations is not at a flowmeter; calculating a pressure drop based on the two pressures; calculating a first superficial gas velocity (SGVₐₗₜ) for the fluidized bed based on the pressure drop; obtaining a second superficial gas velocity (SGV_{fm}) for the fluidized bed using the flowmeter; comparing the SGVₐₗₜ and the SGV_{fm}; and operating the fluidized bed reactor system based at least in part on said comparison of the SGVₐₗₜ and the SGV_{fm} (e.g., modifying an operating parameter of the fluidized bed reactor system when the comparison of the SGVₐₗₜ and the SGV_{fm} fits a threshold requirement).

Another nonlimiting example method of the present disclosure comprises: measuring a pressure for each of two different locations within a fluidized bed reactor system that comprises a reactor capable of containing a fluidized bed and a cycle gas loop, wherein one or both of the two different locations is not at a flowmeter; calculating a pressure drop based on the two pressures; calculating a superficial gas velocity (SGVₐₗₜ) for the fluidized bed based on the pressure drop; and operating the fluidized bed reactor system based at least in part on the SGVₐₗₜ.

A nonlimiting example fluidized bed reactor system of the present disclosure comprises: a reactor capable of containing a fluidized bed; a cycle gas loop; two or more pressure sensors located in different locations within the fluidized bed reactor system, wherein one or both of the two different locations is not at a flowmeter; and a computing device configured to receive pressure data from the two or more pressure sensors and comprising: a processor; a memory coupled to the processor; and instructions provided to the memory, wherein the instructions are executable by the processor to perform a method comprising: calculate a pressure drop based on the pressure data; and calculate a superficial gas velocity (SGVₐₗₜ) for the fluidized bed based on the pressure drop.

These and other features and attributes of the disclosed methods and system of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a diagram of a nonlimiting portion of a fluidized bed reactor system of the present disclosure.

FIG. 2 is a diagram of a nonlimiting portion of a fluidized bed reactor system of the present disclosure

FIG. 3 illustrates a comparison between the superficial gas velocities determined via the modified Ergun equation and the Venturi flowmeter measurement for all metallocene grades.

FIG. 4 illustrates a comparison between the superficial gas velocities determined via the modified Ergun equation and the Venturi flowmeter measurement for a single metallocene grades.

FIG. 5 is plant data used for determining an empirical correlation for Kₒᵥₑᵣₐₗₗ.

FIG. 6 is a graph of SGV_{fm} vs. SGV_{ΔP} for a commercial polyolefin reactor over a 3.5 month period.

### DETAILED DESCRIPTION

The present application relates to systems and methods for determining the superficial gas velocity in fluidized bed reactors, for example, polyolefin reactors. More specifically, the methods and systems described herein involve determining the superficial gas velocity in a fluidized bed using one or more pressure drops within the fluidized bed reactor system, including pressure drops in the fluidized bed, sections of the cycle gas piping, or both, but not pressure drops across a flowmeter (e.g., a Venturi flowmeter, a Pitot tube, or the like) or related instrument.

As used herein, the abbreviation “SGVₐₗₜ” is used generally to refer to a superficial gas velocity calculated or otherwise obtained using a pressure drop within the fluidized bed reactor system where said pressure drop is not derived from a flowmeter (e.g., a Venturi flowmeter, a Pitot tube, or the like). As used herein, the abbreviation “SGV_{fm}” is used generally to refer to a superficial gas velocity calculated or otherwise obtained based on flowmeter measurements (e.g., a Venturi flowmeter, a Pitot tube, or the like) from within the fluidized bed reactor system.

Using the pressure drop within the fluidized bed reactor system, the superficial gas velocity (SGVₐₗₜ) may be calculated based on said pressure drop. The specific choice of equation used to estimate the superficial gas velocity depends on the two locations across which the pressure drop is measured or otherwise obtained.

The pressure drop measurements for the SGVₐₗₜ rely on pressure sensors (e.g., differential pressure sensors) that are typically more robust and less prone to fouling, drift, and other sources of inaccuracy as compared to the Venturi flowmeters. Accordingly, the SGVₐₗₜ may be more accurate and provide for a more confident monitoring of the fluidized bed reactor as compared to the SGV_{fm}.

The methods and systems described herein provide multiple avenues for implementing the SGVₐₗₜ with or without the SGV_{fm}. For example, the SGV_{fm} and the SGVₐₗₜ may be used together, where comparisons between the superficial gas velocities may identify drift in the SGV_{fm}. Identifying drift, or other inaccuracies, early may mitigate either system downtime or production losses caused by operating the system based on the inaccurate superficial gas velocity. Identification of SGV_{fm} drift may, for example, be achieved by implementing deviation alarming between SGV_{fm} and SGVₐₗₜ in the plant's process control system.

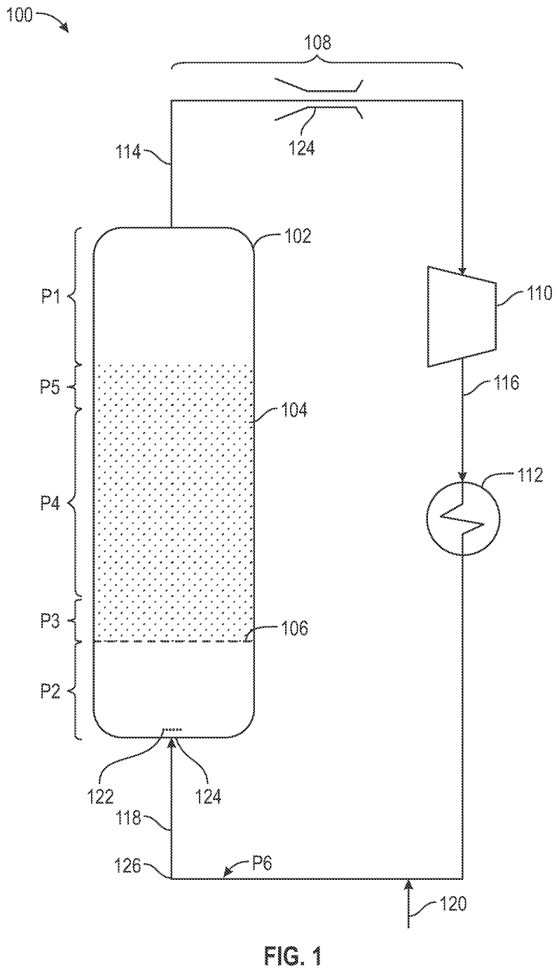

FIG. 1 is a diagram of a nonlimiting fluidized bed reactor system 100 of the present disclosure. The fluidized bed reactor system 100 includes a fluidized bed reactor 102 (or simply reactor 102) for containing a fluidized bed 104 above a distributor plate 106 located in the reactor 102. The fluidized bed reactor system 100 also includes a cycle gas loop 108 where gas effluent from the reactor 102 is compressed via compressor 110 and cooled via heat exchanger 112. As illustrated, a line 114 is used for conveying the gas effluent from the reactor 102 to the compressor 110, a line 116 is used for conveying the compressed gas effluent to the heat exchanger 112, and a line 118 is used for conveying the resultant recycle gas (the cooled and compressed gas effluent) to the reactor 102. The lines 114, 116, 118 provide simple flow or conveyance illustrations and may, in reality, be composed of multiple lines and have equipment (e.g., sensors, pumps, and the like) located along said lines 114, 116, 118.

In the illustrated fluidized bed reactor system 100, feedstock is added to the cycle gas loop 108 via line 120 downstream of the heat exchanger 112 along line 118. Further, a Venturi flowmeter 124 or similar hardware is located upstream of the compressor 110 along line 114. The fluidized bed reactor system 100 further includes a disc 122 within the reactor 102 for distributing as the feed coming into the reactor 102 from line 118 at inlet 124.

The systems and methods of the present disclosure herein use pressure drop values across two locations in the system (e.g., a portion of the fluidized bed reactor where said portion may be being defined between two locations within the fluidized bed reactor system) for calculating SGVₐₗₜ, as opposed to across a flowmeter as done with the Venturi 124. The two locations across which the pressure drop is defined (e.g., the portion of the fluidized bed reactor system from which the pressure drop is obtained) dictates on the equation used for calculating the SGVₐₗₜ.

Referring back to FIG. 1, six locations P1-P6 in the fluidized bed reactor system 100 are illustrated as locations that can be used to define the portion of the fluidized bed reactor system from which the pressure drop is obtained. That is, the pressure drop may be for a portion of the fluidized bed reactor system defined between P1 and P2, between P1 and P3, between P1 and P4, between P1 and P5, between P1 and P6, between P2 and P3, between P2 and P4, between P2 and P5, between P2 and P6, between P3 and P4, between P3 and P5, between P3 and P6, between P4 and P5, between P4 and P6, or between P5 and P6. The first location P1 is the reactor pressure measured above the fluidized bed 104. The second location P2 is the reactor pressure between the distributor plate 106 and disc 122. The third location P3 is in the reactor above the distributor plate 106 and within the bottom 10 vol % of the fluidized bed portion 104 of the reactor 102. The fourth location P4 is the middle 80 vol % of the fluidized bed portion 104 of the reactor 102. The fifth location P5 is the top 10 vol % of the fluidized bed portion 104 of the reactor 102. The sixth location P6 is in the line 118 after feedstock is added via line 120 and before an elbow 126 closest to the inlet 124 of the reactor 102.

The pressure at each of these locations P1-P6 may be measured using (a) individual pressure sensor at each location or (b) a differential pressure sensor connected to the two locations. In either instance, taps (not illustrated) may be included in the fluidized bed reactor system 100 for connecting either type of pressure sensors. Examples of pressure sensors may include, but are not limited to, pressure transducers, viscometers, thermocouples, the like, and any combination thereof. The types of pressure sensors utilized may include, but are not limited to, differential, acoustic, electromagnetic, piezoelectric, optical, potentiometric, the like, or any combination thereof. Examples of commercially available pressure sensors may include, but are not limited to, the DYTRAN 2006M1 acoustic pressure sensor, the OMEGA PX3005 piezoelectric pressure sensor, the EMERSON ROSEMOUNT 3051 pressure sensors, and the HONEYWELL FP2000 potentiometric pressure sensor.

Table 1 provides a list of example equations for calculating the SGVₐₗₜ and the corresponding pressure drop locations within a fluidized bed reactor system used as an input for said equation. Each of the equations is described in more detail herein.

TABLE 1
Examples of SGVₐₗₜ equations and corresponding pressure
drop locations within a fluidized bed reactor system

| Equation | Pressure Drop Location |
|---|---|
| SGVₐₗₜ Method A | Across the fluidized bed (e.g., P3 minus P1 of |
| (modified Ergun model) | FIG. 1) |
| SGVₐₗₜ Method B | Across the fluidized bed (e.g., P3 minus P1 of |
| (Wen-Yu model) | FIG. 1) |
| SGVₐₗₜ Method C | Across the fluidized bed (e.g., P3 minus P1 of |
| (Beetstra model) | FIG. 1) |
| SGVₐₗₜ Method D | Across the fluidized bed (e.g., P3 minus P1 of |
| (Igci model) | FIG. 1) |
| SGVₐₗₜ Method E | Across the reactor inlet piping (e.g., P6 minus |
| | P2 of FIG. 1) |
| SGVₐₗₜ Method F | Across the distributor plate (e.g., P3 minus P2 |
| | of FIG. 1) |
| SGVₐₗₜ Method G | Across the fluidized bed and distributor plate |
| | (e.g., P1 minus P2 of FIG. 1) |
| SGVₐₗₜ Method H | From the reactor inlet piping to above the |
| | fluidized bed (e.g., P1 minus P6 of FIG. 1) |

### SGVₐₗₜ Method a (Modified Ergun Equation)

A first example SGVₐₗₜ method is a modified Ergun equation presented in EQ. 1.

$$\frac{Δ P}{h} = \frac{18 μ U ϕ}{( 1 - ϕ ) {d}^{2}} * ( {C}_{1} \frac{ϕ}{{( 1 - ϕ )}^{2}} + {C}_{2} \frac{Re}{{( 1 - ϕ )}^{2}} ) \qquad EQ . 1$$

where ΔP is the pressure drop across the fluidized bed (P3 minus P1 of FIG. 1) (Pascals, Pa), h is the height between the two locations across which the pressure drop is measured (e.g., the height between the pressure taps used for measuring the differential pressure between P3 and P1) (meters, m), μ is fluid viscosity in (Pa*sec), U is superficial gas velocity (m/sec), ϕ is solids volume fraction (dimensionless), d is particle size (m), C₁ and C₂ are coefficients (dimensionless, calculated per EQ. 2), Re is Reynolds number where Re=ρUd/μ, and ρ is fluid density (kg/m³).

Values like gas density and viscosity may change during operation and can be accurately predicted from temperature, pressure, and composition data, which may each be measured or otherwise obtained in real time and/or periodically. Alternatively, such values that change during operation may be treated as constants, which reduces the accuracy and cost of the method. A combination of the foregoing may be implemented where some values are constants and other are measured or otherwise obtained in real time and/or periodically.

The coefficients C₁ and C₂ may have the form of EQ. 2.

Cₙ=aₙε^{b}^{ₙ}+cₙ EQ. 2

where n is the number of the coefficient (e.g., 1 for C₁), and aₙ, bₙ, and cₙ are additional constants.

C₁ and C₂ of EQ. 1 and a, b, and c of EQ. 2 may be unique for each reactor size and type. The constants C₁ and C₂ of EQ. 1 and/or a, b, and c of EQ. 2 may be determined using experimental superficial gas velocity data obtained from a Venturi flowmeter or other suitable means. Preferably, the data used to derive the constants has a high accuracy (e.g., high certainty that the Venturi flowmeter was not drifting or fouled). As additional data is collected during the method and/or operation of the systems described herein, the constants C₁ and C₂ of EQ. 1 and/or a, b, and c of EQ. 2 may be updated using superficial gas velocity data acquired independently from the modified Ergun equation. In this way, the determination of the constants using the Venturi flowmeter or other suitable means may be considered a feedback loop that allows for constant refining of the modified Ergun equation to provide higher accuracy and confidence in the superficial gas velocity data.

Once the constants are determined and/or provided from a previous determination and the properties of the fluidized bed (e.g., length, porosity, and density) determined, EQ. 1 has two variables: pressure drop across the fluidized bed and superficial gas velocity.

The systems described herein may include pressure sensors for measuring the pressure drop across the fluidized bed so that solving EQ. 1 (the modified Ergun equation) yields the SGVₐₗₜ. The methods described herein may include measuring the pressure drop across the fluidized bed of a fluidized bed reactor system and solving EQ. 1 to yield a SGVₐₗₜ. Said SGVₐₗₜ may be used, as described further herein, for operating the fluidized bed reactor system alone or in conjunction with the SGV_{fm}.

### SGVₐₗₜ Method B

A second example SGVₐₗₜ method is presented in EQ. 3.

$$\frac{Δ P}{h} = \frac{18 μ U ϕ}{( 1 - ϕ ) {d}^{2}} * ( {( 1 - ϕ )}^{- 3.65} ( {C}_{1} + {C}_{2} {Re}^{0.687} ) ) \qquad EQ . 3$$

where ΔP is the pressure drop across the fluidized bed (P3 minus P1 of FIG. 1) (Pa), h is the height between the two locations across which the pressure drop is measured (e.g., the height between the pressure taps used for measuring the differential pressure between P3 and P1) (m), μ is fluid viscosity in (Pa*sec), U is superficial gas velocity (m/sec), ϕ is solids volume fraction (dimensionless), d is particle size (m), C₁ and C₂ are coefficients (dimensionless, calculated per EQ. 2), Re is Reynolds number where Re=ρUd/μ, and ρ is fluid density (kg/m³).

### SGVₐₗₜ Method C

A third example SGVₐₗₜ method is presented in EQ. 4.

$$\frac{Δ P}{h} = \frac{18 μ U ϕ}{( 1 - ϕ ) * {d}^{2}} ( {C}_{1} [ \frac{ϕ}{{( 1 - ϕ )}^{2}} + {( 1 - ϕ )}^{2} ( 1 + 1.5 {ϕ}^{\frac{1}{2}} ) ] + {C}_{2} \frac{Re}{{( 1 - ϕ )}^{2}} [ \frac{{( 1 - ϕ )}^{- 1} + 3 ϕ ( 1 - ϕ ) + 8.4 {Re}^{- 0.343}}{1 + {10}^{3 ϕ} {Re}^{- \frac{( 1 + 4 ϕ )}{2}}} ] ) \qquad EQ . 4$$

where ΔP is the pressure drop across the fluidized bed (P3 minus P1 of FIG. 1) (Pa), h is the height between the two locations across which the pressure drop is measured (e.g., the height between the pressure taps used for measuring the differential pressure between P3 and P1) (m), μ is fluid viscosity in (Pa*sec), U is superficial gas velocity (m/sec), ϕ is solids volume fraction (dimensionless), d is particle size (m), C₁ and C₂ are coefficients (dimensionless, calculated per EQ. 2), Re is Reynolds number where Re=ρUd/μ, and ρ is fluid density (kg/m³).

### SGVₐₗₜ Method D

A fourth example SGVₐₗₜ method is presented in EQS. 5-7.

$$\frac{Δ P}{h} = \frac{18 μ U ϕ}{( 1 - ϕ ) * {d}^{2}} * [ {( 1 - ϕ )}^{- 3.65} ( {C}_{1} + {C}_{2} {Re}^{0.687} ) ] * ( 1 - fH ) \qquad EQ . 5$$

$$f = \frac{{Fr}^{- 1.6}}{{Fr}^{- 1.6} + 0.4} , \qquad EQ . 6$$

$$H = \{ \begin{matrix}2.7 {ϕ}^{0.234} , & ϕ < 0.0012 \\ - 0.019 {ϕ}^{- 0.455} + 0.963 , & 0.0012 \leq ϕ < 0.014 \\ 0.868 {e}^{- 0.38 ϕ} - 0.176 {e}^{- 119.2 ϕ} , & 0.014 \leq ϕ < 0.25 \\ - \frac{4.59}{{10}^{5}} {e}^{19.75 ϕ} + 0.852 {e}^{- 0.268 ϕ} , & 0.25 \leq ϕ < 0.455 \\ \begin{matrix}( ϕ - 0.59 ) ( - 1501 {ϕ}^{3} + 2203 {ϕ}^{2} - \\ 1054 ϕ + 162 ) ,\end{matrix} & 0.455 \leq ϕ < 0.59 \\ 0 , & ϕ \geq 0.59\end{matrix} \qquad EQ . 7$$

where ΔP is the pressure drop across the fluidized bed (P3 minus P1 of FIG. 1) (Pa), h is the height between the two locations across which the pressure drop is measured (e.g., the height between the pressure taps used for measuring the differential pressure between P3 and P1) (m), μ is fluid viscosity in (Pa*sec), U is superficial gas velocity (m/sec), ϕ is solids volume fraction (dimensionless), d is particle size (m), C₁ and C₂ are coefficients (dimensionless, calculated per EQ. 2), Re is Reynolds number where Re=ρUd/μ, ρ is fluid density (kg/m³), Fr is Froude number where Fr=vₜ²/(gL), vₜ is single-particle terminal velocity (m/sec), g is gravitational acceleration (m/s²), and L is resolution length scale of the model (also known as reactor diameter) (m).

### SGVₐₗₜ Method E

A sixth example SGVₐₗₜ method is presented in EQS. 8-9.

dP=0.5ρU²Kₒᵥₑᵣₐₗₗ EQ. 8

Kₒᵥₑᵣₐₗₗ=K_{elbow}+Kₑₓᵢₜ+K_{disc}+K_{static} EQ. 9

where dP is the pressure drop across the reactor inlet piping (P6 minus P2 of FIG. 1) (Pa), ρ is the gas density at the reactor inlet (kg/m³), U is the superficial gas velocity (m/sec), and Kₒᵥₑᵣₐₗₗ or K factor is the sum of the pressure drop loss coefficients (ΣKᵢ) between where each of the locations defining the pressure drop (e.g., between P6 and P2 of FIG. 1), which may include, but is not limited to, K_{friction}, K_{elbow}, Kₑₓᵢₜ, K_{disc}, K_{statichead}, and any combination thereof. EQ. 9 for Kₒᵥₑᵣₐₗₗ is a nonlimiting example equation that can be changed to account for the configuration of the system.

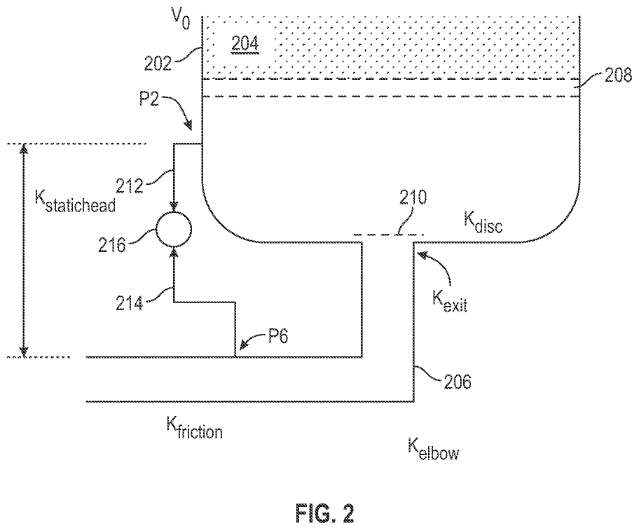

The K factor depends on the configuration and dimensions of the reactor inlet piping (horizontal and vertical), number and type of pipefittings, or other internal components that would result in a pressure drop in the system between points P6 and P2. In summary, Kₒᵥₑᵣₐₗₗ is a combination of the individual pressure drop correction factors needed to account for the pressure drop across the reactor inlet piping line. FIG. 2 is a diagram of a nonlimiting example reactor inlet piping ΔP instrument connections illustrating where correction factors may be accounted for. In the illustrated portion of a fluidized bed reactor system, a line 206 provides gas feed (e.g., recycled gas optionally augmented with fresh reactant gas) to a fluidized bed reactor 202 capable of containing a fluidized bed 204 above a distributor plate 208, where the line 206 connects to the reactor 202 (e.g., at an inlet) and within the reactor 202 is illustrated a disc 210 that assists with distributing the gas and liquid feed into the reactor 202 to prevent liquid pooling. The system also includes tap 212 that connects the bottom portion of the reactor 202 between the distributor plate 208 and disc 210 to a differential pressure meter 216 and tap 214 that connects the line 206 before the elbow to the differential pressure meter 216.

For calculating SGVₐₗₜ according to EQ. 8 for the illustrated configuration in FIG. 2 using a pressure drop of P6 minus P2, correction factors for friction pressure drop in the line 206 (K_{friction}) between P6 and the elbow, for the elbow in the line 206 (K_{elbow}), for the connection between line 206 and the reactor (Kₑₓᵢₜ), for the disc 210 (K_{disc}), and for the vertical distance of the bypass line (K_{statichead}) should be considered. In this example, Kₒᵥₑᵣₐₗₗ is the summation of the five foregoing Ks. Kₒᵥₑᵣₐₗₗ may be determined using plant data to fit EQ. 8. Alternatively, Kₒᵥₑᵣₐₗₗ may be calculated.

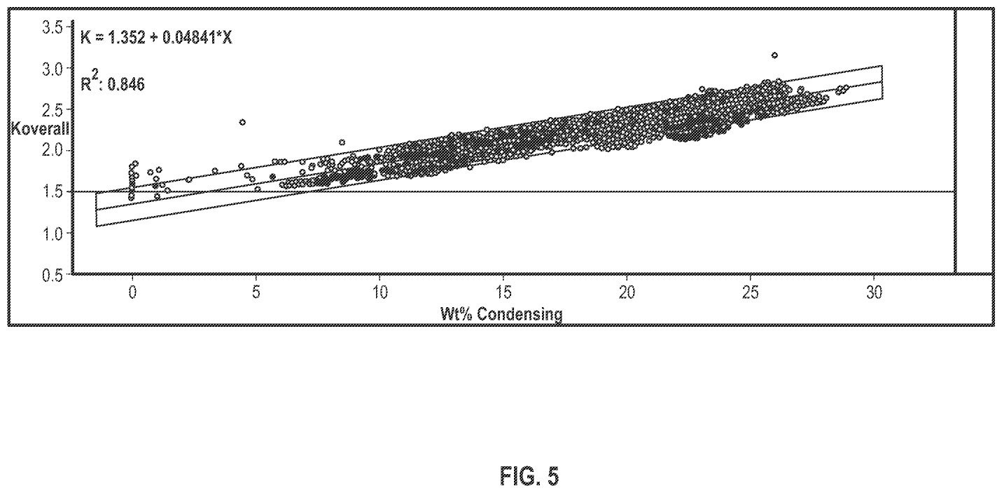

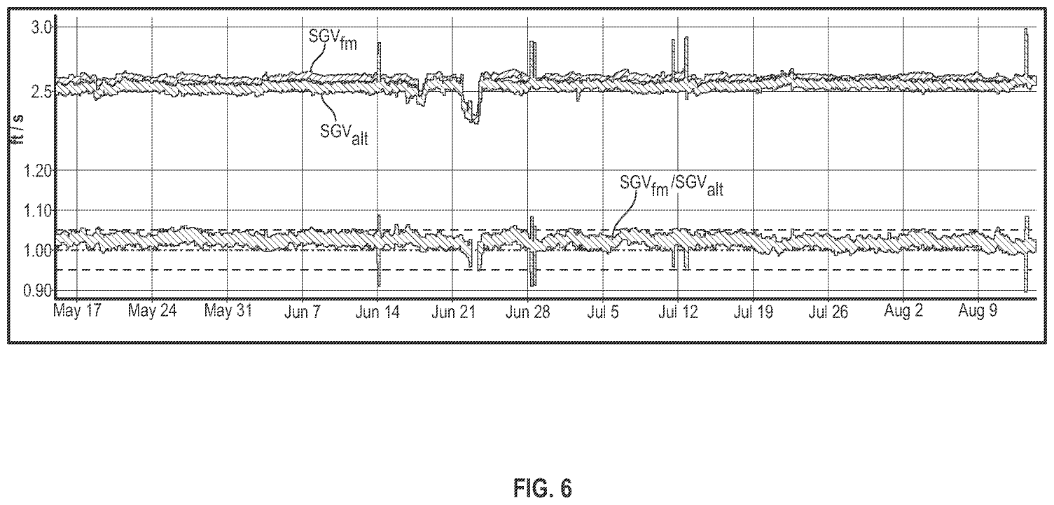

For two-phase flow, known as condense mode or super-condense mode operation in a fluidized bed process, where the wt % cond frac or wt % condensing at the reactor inlet is >0 and less than 50%, but not limited to 50%, the Kₒᵥₑᵣₐₗₗ will vary as a function of wt % condensing. An empirical correlation (EQ. 11) for Kₒᵥₑᵣₐₗₗ can be developed using plant data (FIG. 5). The data used for the correlation needs to be taken over a period of time when the Venturi flow meter is not fouled or accuracy of the flow meter is not in question. Kₒᵥₑᵣₐₗₗ as shown by EQ. 10 can be calculated by re-arranging EQ. 11 and solving for Kₒᵥₑᵣₐₗₗ. FIG. 6 shows SGV_{fm} vs. SGVₐₗₜ (top traces) for a commercial polyolefin reactor over a 3.5 month period. The ratio of SGV_{fm} to SGVₐₗₜ (bottom trace) shows SGVₐₗₜ to be within 3% of the Venturi SGV.

$${K}_{overall} = {( \frac{2 g * 144 * Δ P}{{ρ}_{i}} ) [ \frac{1}{{v}_{0} * ( 1 - wt \% cond frac )} * ( \frac{{ρ}_{i} {A}_{i}}{{ρ}_{o} {A}_{o}} ) ]}^{2} ) \qquad EQ . 10$$

$${K}_{Overall} = α + β * Wt \% Cond Fraction \qquad EQ . 11$$

### SGVₐₗₜ Method F

A fifth example SGVₐₗₜ method is presented in EQS. 12-13.

dP=0.5ρU²Kₒᵥₑᵣₐₗₗ EQ. 12

Kₒᵥₑᵣₐₗₗ=Kₚₗₐₜₑ EQ. 13

where dP is the pressure drop across the distributor plate (P3 minus P2 of FIG. 1) (Pa), ρ is the gas density at the reactor inlet (kg/m³), U is the superficial gas velocity (m/sec), and Kₒᵥₑᵣₐₗₗ or K factor is the sum of the pressure drop loss coefficients (ΣKᵢ) between where each of the locations defining the pressure drop (e.g., between P3 and P2 of FIG. 1), which may include, but is not limited to, Kₚₗₐₜₑ. EQ. 13 for Kₒᵥₑᵣₐₗₗ is a nonlimiting example equation that can be changed to account for the configuration of the system. Kₚₗₐₜₑ is determined as described for the K values described in Method E.

### SGVₐₗₜ Method G

A seventh example SGVₐₗₜ method is presented in EQS. 14-15.

$$dP = 0.5 ρ {U}^{2} {K}_{overall} + h * \frac{18 μ U ϕ}{( 1 - ϕ ) {d}^{2}} * ( {C}_{1} \frac{ϕ}{{( 1 - ϕ )}^{2}} + {C}_{2} \frac{Re}{{( 1 - ϕ )}^{2}} ) \qquad EQ . 14$$

$${K}_{overall} = {K}_{plate} \qquad EQ . 15$$

where dP is the pressure drop across the fluidized bed and distributor plate (P1 minus P2 of FIG. 1) (Pa), ρ is the gas density at the reactor inlet (kg/m³), U is the superficial gas velocity (m/sec), Kₒᵥₑᵣₐₗₗ or K factor is the sum of the pressure drop loss coefficients (ΣKᵢ) between where each of the locations defining the pressure drop (e.g., between P1 and P2 of FIG. 1), which may include, but is not limited to, Kₚₗₐₜₑ, h is the height from the top of the distributor plate to P1 (m), μ is fluid viscosity in (Pa*sec), U is superficial gas velocity (m/sec), ϕ is solids volume fraction (dimensionless), d is particle size (m), C₁ and C₂ are coefficients (dimensionless, calculated per EQ. 2), Re is Reynolds number where Re=ρUd/μ, and ρ is fluid density (kg/m³). EQ. 15 for Kₒᵥₑᵣₐₗₗ is a nonlimiting example equation that can be changed to account for the configuration of the system. Kₚₗₐₜₑ is determined as described for the K values described in Method E.

### SGVₐₗₜ Method H

An eighth example SGVₐₗₜ method is presented in EQS. 16-17.

$$dP = 0.5 ρ {U}^{2} {K}_{overall} + h * \frac{18 μ U ϕ}{( 1 - ϕ ) {d}^{2}} * ( {C}_{1} \frac{ϕ}{{( 1 - ϕ )}^{2}} + {C}_{2} \frac{Re}{{( 1 - ϕ )}^{2}} ) \qquad EQ . 16$$

$${K}_{overall} = {K}_{plate} + {K}_{elbow} + {K}_{exit} + {K}_{disc} + {K}_{statichead} \qquad EQ . 17$$

where dP is the pressure drop across the fluidized bed and distributor plate (P1 minus P6 of FIG. 1) (Pa), ρ is the gas density at the reactor inlet (kg/m³), U is the superficial gas velocity (m/sec), and Kₒᵥₑᵣₐₗₗ or K factor is the sum of the pressure drop loss coefficients (ΣKᵢ) between where each of the locations defining the pressure drop (e.g., between P1 and P6 of FIG. 1), which may include, but is not limited to, Kₚₗₐₜₑ, K_{friction}, K_{elbow}, Kₑₓᵢₜ, K_{disc}, K_{statichead}, and any combination thereof, h is the height from the top of the distributor plate to P1 (m), μ is fluid viscosity in (Pa*sec), U is superficial gas velocity (m/sec), ϕ is solids volume fraction (dimensionless), d is particle size (m), C₁ and C₂ are coefficients (dimensionless, calculated per EQ. 2), Re is Reynolds number where Re=ρUd/μ, and ρ is fluid density (kg/m³). EQ. 17 for K overall is a nonlimiting example equation that can be changed to account for the configuration of the system. Kₚₗₐₜₑ is determined as described for the K values described in Method E.

### Methods and Systems Implementing a SGVₐₗₜ

The methods and systems described herein may use a pressure drop within a portion of a fluidized bed reactor system for determining SGVₐₗₜ and may optionally further include a Venturi flowmeter for determining SGV_{fm}. The SGVₐₗₜ optionally in conjunction with the SGV_{fm} may be used during the operation of the fluidized bed reactor system.

For example, a method of the present disclosure may comprise: obtaining a pressure for each of two different locations within a fluidized bed reactor system that comprises a reactor capable of containing a fluidized bed and a cycle gas loop; calculating a pressure drop based on the two pressures; calculating a superficial gas velocity (SGVₐₗₜ) for the fluidized bed based on the pressure drop; and operating the fluidized bed reactor system based at least in part on the SGVₐₗₜ. Operating the fluidized bed reactor system may include maintaining or changing one or more operating parameters like reactor temperature, reactor pressure, reactant feed rate, purge rate, reactor composition, the like, and any combination thereof. For example, in reactor composition, the actual composition and/or concentrations of reactants and/or induced condensing agents may be adjusted to effect a change in the reactor composition.

In another example, a method of the present disclosure may comprise: obtaining a pressure for each of two different locations within a fluidized bed reactor system that comprises a reactor capable of containing a fluidized bed and a cycle gas loop; calculating a pressure drop based on the two pressures; calculating a first superficial gas velocity (SGVₐₗₜ) for the fluidized bed based on the pressure drop; obtaining a second superficial gas velocity (SGV_{fm}) for the fluidized bed using a Venturi flowmeter; comparing the SGVₐₗₜ and the SGV_{fm}; and operating the fluidized bed reactor system based at least in part on the comparison of the SGVₐₗₜ and the SGV_{fm} (for instance, when the comparison fits a threshold requirement, one or more operating parameters such as those just discussed may be changed, which may help adjust to an unexpected or unacceptable deviation between the SGV values). The method can further include taking an action if the comparison of the SGVₐₗₜ and the SGV_{fm} is beyond the threshold value.

Example of such actions may include, but are not limited to, triggering an alarm, performing remedial actions on the Venturi flowmeter (e.g., performing a blowback procedure on the Venturi flowmeter), modifying one or more operating parameters of the fluidized bed reactor system, the like, and any combination thereof. Another action could include adding a flow bias or correction factor to the indicated Venturi flow so that the reactor velocity can be controlled in the correct operating window until the issue with the Venturi flow deviation could be resolved by cleaning the leads or throat of the Venturi flow meter during a planned reactor outage. It will be appreciated that these “actions” as just discussed do not necessarily involve an actual change to operating parameters, but instead may only entail adjustments to control algorithms and/or to measurements, thereby achieving higher confidence in control parameters before problems in actual operation occur.

Regarding the threshold requirement, when using the SGV_{fm} in tandem with the SGVₐₗₜ, a difference between the two values as low as 0.05 ft/s may, for example, be cause for an action to be taken (similarly, a difference as low as 0.10, 0.125, 0.15, 0.175, or 0.2 ft/s may be cause for an action to be taken). Further, a difference of 0.20 ft/s or more, such as 0.22 ft/s or more or 0.25 ft/s or more, between the SGVₐₗₜ and the SGV_{fm} may, for example, indicate a partially fouled Venturi flowmeter or another issue that may require immediate attention. Of course, the skilled artisan with the benefit of this disclosure could set any desired threshold difference to trigger (or indicate the possible desirability of) a given action, and/or a change in process conditions. And, as just alluded to, it is contemplated that more than one thresholds could be set, each linked to different action and/or change in process conditions (following the example just noted, a first threshold could be a difference greater than or equal to 0.050 ft/s; and a second threshold could be a difference greater than or equal to 0.200 ft/s; and each threshold could be used to trigger a different action and/or change of operating parameters). Again, any number of thresholds at any difference levels may readily be employed by the skilled artisan with the benefit of this disclosure; all such threshold numbers and amounts would fall within the scope of the present invention.

The fluidized bed reactor systems described herein may be suitable for producing a polyolefin (e.g., polyethylene, polypropylene, polybutylene, and the like). For example, methods described herein may further comprise producing a polyolefin in the fluidized bed reactor system.

Various aspects of the systems and methods described herein utilize computer systems. Such systems and methods can include a non-transitory computer readable medium containing instructions that, when implemented, cause one or more processors to carry out the methods described herein.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

The methods described herein can be performed using computing devices or processor-based devices that include a processor; a memory coupled to the processor; and instructions provided to the memory, wherein the instructions are executable by the processor to perform the methods described herein. The instructions can be a portion of code on a non-transitory computer readable medium. Any suitable processor-based device may be utilized for implementing all or a portion of embodiments of the present techniques, including without limitation personal computers, networks of personal computers, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

For example, a fluidized bed reactor system may comprise: a reactor capable of containing a fluidized bed; a cycle gas loop; two or more pressure sensors; and a computing device configured to receive pressure data from the two or more pressure sensors and comprising: a processor; a memory coupled to the processor; and instructions provided to the memory, wherein the instructions are executable by the processor to perform a method comprising: calculate a pressure drop based on the pressure data; and calculate a first superficial gas velocity (SGVₐₗₜ) for the fluidized bed based on the pressure drop. The method may also include send a signal to a portion of the fluidized bed reactor system, wherein the signal is a change in an operating parameter of said portion of the fluidized bed reactor system.

In another example, a fluidized bed reactor system may comprise: a reactor capable of containing a fluidized bed; a cycle gas loop; two or more pressure sensors; a Venturi flowmeter; and a computing device (a) configured to receive pressure data from the two or more pressure sensors and received data from the Venturi flowmeter; and (b) comprising: a processor; a memory coupled to the processor; and instructions provided to the memory, wherein the instructions are executable by the processor to perform a method comprising: calculate a pressure drop based on the pressure data; calculate a first superficial gas velocity (SGVₐₗₜ) for the fluidized bed based on the pressure drop; obtain a second superficial gas velocity (SGV_{fm}) based on the data from the Venturi flowmeter; compare the SGVₐₗₜ and the SGV_{fm}; and cause an action to occur if the comparison of the SGVₐₗₜ and the SGV_{fm} fits a threshold requirement (e.g., by sending a signal to a portion of the fluidized bed reactor system and/or outputting an alarm).

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### Examples

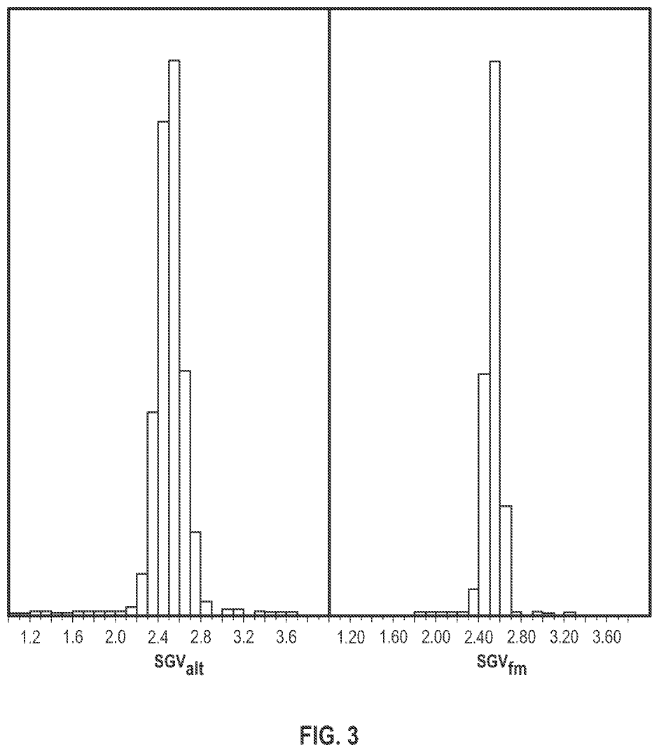

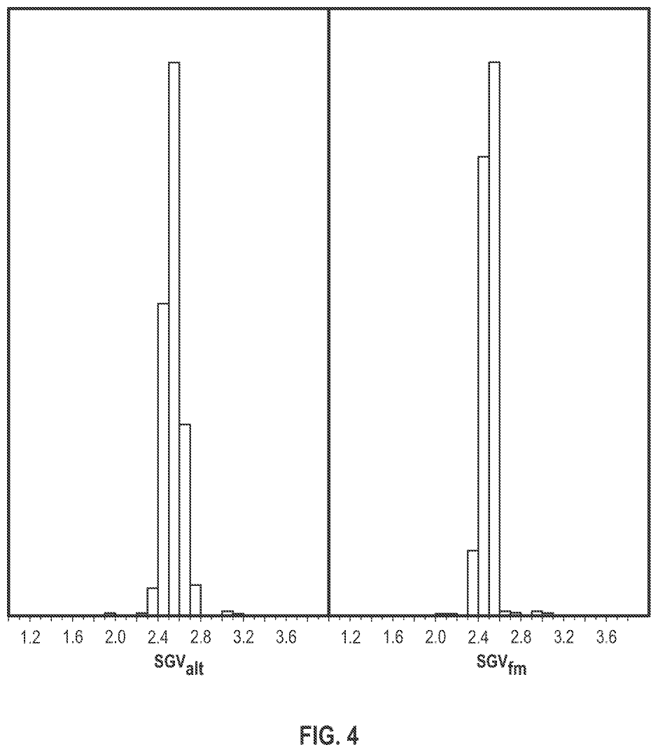

Historical data was gathered from a fluidized bed polyethylene reactor that was run for several months. The data was gathered during operation for both the Venturi flowmeter and the sensor measurements required to determine the superficial gas velocity via a modified Ergun equation (EQ. 1). During this time, several metallocene grades were generated, and the data was then able to be analyzed across all metallocene grades. Across all metallocene grades, as illustrated in FIG. 3, the superficial gas velocity from the Ergun equation was in agreement with the superficial gas velocity obtained from the Venturi flowmeter, although the modified Ergun equation generated more noise around the accurate reading. Additionally, the data was analyzed for an individual metallocene grade to determine the trend of an individual metallocene grade. When analyzed on an individual level, as illustrated in FIG. 4, the noise was reduced. It may be seen that the modified Ergun equation generated a superficial gas velocity that was in agreement with the superficial gas velocity obtained from the Venturi flowmeter while having less noise around the accurate reading. The modified Ergun equation may be seen to generate the superficial gas velocity with a similar accuracy to the Venturi flowmeter.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
obtaining a pressure measurement for each of two different locations within a fluidized bed reactor system that comprises a reactor capable of containing a fluidized bed and a cycle gas loop, wherein one or both of the two different locations is not at a flowmeter;
calculating a pressure drop based on the two obtained pressure measurements;
calculating a first superficial gas velocity (SGVₐₗₜ) for the fluidized bed based on the pressure drop;
obtaining a second superficial gas velocity (SGV_{fm}) for the fluidized bed using the flowmeter;
comparing the SGVₐₗₜ and the SGV_{fm}; and
operating the fluidized bed reactor system based at least in part on said comparing of the SGVₐₗₜ and the SGV_{fm}.

2. The method of claim 1, wherein operating the fluidized bed reactor based at least in part on said comparing of the SGVₐₗₜ and the SGV_{fm} comprises:
modifying an operating parameter of the fluidized bed reactor system when the comparison of the SGVₐₗₜ and the SGV_{fm} fits a threshold requirement.

3. The method of claim 2, wherein the operating parameter comprises a reactor temperature, a reactor pressure, a reactant feed rate, a purge rate, reactor composition, or any combination thereof.

4. The method of claim 1, further comprising taking an action if the comparison of the SGVₐₗₜ and the SGV_{fm} fits an action threshold requirement.

5. The method of claim 4, wherein the action comprises one or more of the following: performing remedial actions on the flowmeter; triggering an alarm; and adding a flow bias or correction factor to the determined SGV_{fm} value so as to control reactor velocity in a desired operating window.

6. The method of claim 1, wherein the comparison is an absolute value of a difference between the SGVₐₗₜ and the SGV_{fm}, and wherein the threshold requirement is the absolute value of the difference between the SGVₐₗₜ and the SGV_{fm} being 0.05 feet per second or greater.

7. The method of claim 1, wherein the comparison is an absolute value of a difference between the SGVₐₗₜ and the SGV_{fm}, and wherein the threshold requirement is the absolute value of the difference between the SGVₐₗₜ and the SGV_{fm} being 0.20 feet per second.

8. The method of claim 1, further comprising:
producing a polyolefin in the fluidized bed reactor system.

9. The method of claim 1, wherein the flowmeter comprises a Venturi flowmeter.

10. The method of claim 1, wherein the flowmeter comprises a Pitot tube.

11. A method comprising:
measuring a pressure for each of two different locations within a fluidized bed reactor system that comprises a reactor capable of containing a fluidized bed and a cycle gas loop, wherein one or both of the two different locations is not at a flowmeter;
calculating a pressure drop based on the two measured pressures;
calculating a superficial gas velocity (SGVₐₗₜ) for the fluidized bed based on the pressure drop;
operating the fluidized bed reactor system based at least in part on the SGVₐₗₜ; and
producing a polyolefin in the fluidized bed reactor system.

12. The method of claim 11, wherein the operating of the fluidized bed reactor comprises:
modifying an operating parameter of the fluidized bed reactor system.

13. The method of claim 12, wherein the operating parameter comprises a reactor temperature, a reactor pressure, a reactant feed rate, a purge rate, reactor composition, or any combination thereof.

14. The method of claim 11, wherein (a) the flowmeter comprises a Venturi flowmeter or (b) the flowmeter comprises a Pitot tube.

15. The method of claim 1, wherein the two different locations within the fluidized bed reactor system comprise a location (P1) at a top portion of the reactor and a location (P3) along a bottom portion of the fluidized bed within the reactor, such that obtaining the pressure measurement for each of said two different locations comprises obtaining a pressure drop across the fluidized bed; and further wherein SGVₐₗₜ is calculated using at least one of the following methods:
(a) a modified Ergun equation having the form of EQ. 1
$$\frac{Δ P}{h} = \frac{18 μ U ϕ}{( 1 - ϕ ) {d}^{2}} * ( {C}_{1} \frac{ϕ}{{( 1 - ϕ )}^{2}} + {C}_{2} \frac{Re}{{( 1 - ϕ )}^{2}} ) \qquad EQ . 1$$
wherein ΔP is the pressure drop across the fluidized bed (Pascals, Pa), h is the height between said two different locations P1 and P3 from which the pressure measurements are taken (meters, m), μ is fluid viscosity in (Pa*sec), U is superficial gas velocity (m/sec), ϕ is solids volume fraction (dimensionless), d is particle size (m), (dimensionless, calculated per EQ. 2), Re is Reynolds number where Re=ρUd/μ, ρ is fluid density (kg/m³), and C₁ and C₂ are dimensionless coefficients calculated per EQ. 2
Cₙ=aₙε^{b}^{ₙ}+cₙ EQ. 2
where n is the number of the coefficient, and aₙ, bₙ, and cₙ are additional constants associated with a given reactor size and type, and may be determined using superficial gas velocity data obtained from a flowmeter;
(b) an equation having the form of EQ. 3
$$\frac{Δ P}{h} = \frac{18 μ U ϕ}{( 1 - ϕ ) {d}^{2}} * ( {( 1 - ϕ )}^{- 3.65} ( {C}_{1} + {C}_{2} {Re}^{0.687} ) ) \qquad EQ . 3$$
wherein each variable is as described in connection with EQ. 1;
(c) an equation having the form of EQ. 4
$$\frac{Δ P}{h} = \frac{18 μ U ϕ}{( 1 - ϕ ) * {d}^{2}} ( {C}_{1} [ \frac{ϕ}{{( 1 - ϕ )}^{2}} + {( 1 - ϕ )}^{2} ( 1 + 1.5 {ϕ}^{\frac{1}{2}} ) ] + {C}_{2} \frac{Re}{{( 1 - ϕ )}^{2}} [ \frac{{( 1 - ϕ )}^{- 1} + 3 ϕ ( 1 - ϕ ) + 8.4 {Re}^{- 0.343}}{1 + {10}^{3 ϕ} {Re}^{- \frac{( 1 + 4 ϕ )}{2}}} ] ) \qquad EQ . 4$$
wherein each variable is as described in connection with EQ. 1; and
(d) an equation having the form of EQ. 5
$$\frac{Δ P}{h} = \frac{18 μ U ϕ}{( 1 - ϕ ) * {d}^{2}} * [ {( 1 - ϕ )}^{- 3.65} ( {C}_{1} + {C}_{2} {Re}^{0.687} ) ] * ( 1 - fH ) \qquad EQ . 5$$
wherein ΔP, h, μ, U, d, Re, C₁ and C₂ are each as described in connection with EQ. 1, f is determined from EQ. 6
$$f = \frac{{Fr}^{- 1.6}}{{Fr}^{- 1.6} + 0.4} , \qquad EQ . 6$$
wherein Fr is Froude number where Fr=vₜ²(gL), vₜ is single-particle terminal velocity (m/sec), g is gravitational acceleration (m/s²), and L is reactor diameter (m), and
H is determined per EQ. 7
$$H = \{ \begin{matrix}2.7 {ϕ}^{0.234} , & ϕ < 0.0012 \\ - 0.019 {ϕ}^{- 0.455} + 0.963 , & 0.0012 \leq ϕ < 0.014 \\ 0.868 {e}^{- 0.38 ϕ} - 0.176 {e}^{- 119.2 ϕ} , & 0.014 \leq ϕ < 0.25 \\ - \frac{4.59}{{10}^{5}} {e}^{19.75 ϕ} + 0.852 {e}^{- 0.268 ϕ} , & 0.25 \leq ϕ < 0.455 \\ \begin{matrix}( ϕ - 0.59 ) ( - 1501 {ϕ}^{3} + 2203 {ϕ}^{2} - \\ 1054 ϕ + 162 ) ,\end{matrix} & 0.455 \leq ϕ < 0.59 \\ 0 , & ϕ \geq 0.59\end{matrix} \qquad EQ . 7$$

16. The method of claim 1, wherein SGVₐₗₜ is calculated using an equation having the form of EQ. 8
dP=0.5ρU₀²Kₒᵥₑᵣₐₗₗ EQ. 8
where dP is the pressure drop between the two different locations from which pressure measurements are obtained (Pa), ρ is the gas density at the reactor inlet (kg/m³), U₀ is the superficial gas velocity (m/sec), and Kₒᵥₑᵣₐₗₗ is a combination of the individual pressure drop correction factors needed to account for the pressure drop between said two different locations from which pressure measurements are obtained.

17. The method of claim 16, wherein Kₒᵥₑᵣₐₗₗ is calculated using an empirical correlation determined from data of past operation of the reactor system over a time period during which accuracy of the flow meter is not in question.

18. The method of claim 16, wherein obtaining the pressure measurement for each of the two different locations within the reactor system comprises obtaining a pressure drop across reactor inlet piping of the reactor system; and further wherein Kₒᵥₑᵣₐₗₗ is determined as Kₒᵥₑᵣₐₗₗ=ΣKᵢ, wherein each Ki is a pressure drop correction factor associated with a location or feature along the reactor inlet piping that causes pressure drop, and further wherein each Kᵢ is selected from the following: K_{friction}, K_{elbow}, Kₑₓᵢₜ, K_{disc}, K_{statichead}, and any combination thereof.

19. The method of claim 16, wherein obtaining the pressure measurement for each of the two different locations within the reactor system comprises obtaining a pressure drop across a distributor plate disposed in a bottom portion of the reactor, and further wherein Kₒᵥₑᵣₐₗₗ is determined as the K value of the distributor plate.

20. The method of claim 1, wherein the two different locations within the fluidized bed reactor system have a distributor plate therebetween, and wherein SGVₐₗₜ is calculated using an equation having the form of EQ. 14
$$dP = 0.5 ρ {U}^{2} {K}_{overall} + h * \frac{18 μ U ϕ}{( 1 - ϕ ) {d}^{2}} * ( {C}_{1} \frac{ϕ}{{( 1 - ϕ )}^{2}} + {C}_{2} \frac{Re}{{( 1 - ϕ )}^{2}} ) \qquad EQ . 14$$
where dP is the pressure drop between the two different locations from which pressure measurements are obtained (Pa), ρ is the gas density at the reactor inlet (kg/m³), U is the superficial gas velocity (m/sec), Kₒᵥₑᵣₐₗₗ is a combination of the individual pressure drop correction factors needed to account for the pressure drop between said two different locations from which pressure measurements are obtained, h is the height from the top of the distributor the location of the two locations that is downstream of the distributor plate, μ is fluid viscosity in (Pa*sec), ϕ is solids volume fraction (dimensionless), d is particle size (m), C₁ and C₂ are coefficients (dimensionless, calculated per EQ. 2), Re is Reynolds number where Re=ρUd/μ, and ρ is fluid density (kg/m³)
Cₙ=aₙε^{b}^{ₙ}+cₙ EQ. 2
where n is the number of the coefficient, and aₙ, bₙ, and cₙ are additional constants associated with a given reactor size and type, and may be determined using superficial gas velocity data obtained from a flowmeter;
and further wherein the two different locations within the fluidized bed reactor system also have therebetween one or both of: reactor inlet piping and a disc; and further wherein Kₒᵥₑᵣₐₗₗ is determined as Kₒᵥₑᵣₐₗₗ=ΣKᵢ, wherein each Ki is a pressure drop correction factor associated with a location or feature along the reactor inlet piping that causes pressure drop, and further wherein each Kᵢ is selected from the following: Kₚₗₐₜₑ, K_{friction}, K_{elbow}, Kₑₓᵢₜ, K_{disc}, and any combination thereof.
